(19) United States
(12) Patent Application Publication
(10) Pub. No.: US 2009/0316905 A1
(43) Pub. Date: Dec. 24, 2009

(54) KEY EXCHANGE THROUGH A SCRAMBLE METHODOLOGY AND SYSTEM

(76) Inventors: AMJAD QURESHI, San Jose, CA (US); Babu Chilukuri, Cupertino, CA (US)

Correspondence Address: Raj Abhyanker LLP, 1580 West, El Camino Real, Suite 8, Mountain View, CA, 94040, US

(21) Appl. No.: 12/141,936

(22) Filed: Jun. 19, 2008

(51) Int. Cl. G06F 9/06

(52) U.S. Cl. 380/277

(57) ABSTRACT

The method, system, and apparatus of key exchange through a scramble methodology and system is disclosed. In one embodiment, the method includes generating a security key associated with a protected media content, disassembling the security key (e.g., may be an unencrypted key) into a set of key bits, generating non-key bits (e.g., may be arbitrarily and/or randomly created binary numbers), placing the non-key bits disbursed between at least some of the set of key bits based on an algorithm of a control register module of a scatter module, algorithmically specifying a number of the set of key bits and the non-key bits in a packet, and communicating the packet and other packets each having the non-key bits disbursed between at least some the set of key bits of each of the packet and the other packets to a gather module.

### FIELD OF TECHNOLOGY

This disclosure relates generally to the technical field of communications and, in one example embodiment, to a method, apparatus, and system of a key exchange through a scramble methodology and system

### BACKGROUND

A digital media player (e.g., a computer, a standalone player, etc.) may process a media content (e.g., a text, audio, still image, animation, and/or video in digital format, a HD DVD, a BlueRay disk, etc.) in encrypted (e.g. a process of transforming information using an algorithm to make it unreadable to anyone not possessing a key) and/or multiplexed (e.g. a process of combining many signals into a single transmission circuit and/or channel) form. The digital media player may decrypt and/or demultiplex the media content before internally transmitting the media content through a series of internal components of the digital media player. For example, a decrypting module may decrypt the media content and transmit it to a media display device (e.g. a codec).

The media content may be internally transmitted through a bus (e.g. a subsystem that transfers data between computer components inside a computer). The bus may not be secure. Furthermore, a software application of the digital media player may temporarily store the media content on a system memory (e.g., the system memory 204 of FIG. 2). The media content may be vulnerable to theft during internal transmission. A hacker (e.g. someone who breaks computer and network security) may be able to steal the media content. Consequently, the media content may be re-encrypted and/or re-multiplexed prior to internal transmission through an unsecured internal system of the digital media player.

A destination circuit (e.g. codec, a media display device, etc.) of the digital media player may need the key (e.g. a piece of information that determines a functional output of a cryptographic algorithm) to decrypt and/or demultiplex the media content. The key may be transmitted to the destination circuit through the unsecured bus and/or stored in the unsecured system memory. Thus, a hacker may also steal the key during internal transmission.

Possession of the key may enable the hacker to decrypt the media content. The hacker may also propagate the key to others (e.g. via the Internet). The propagation of the key to others may allow a large number of people to bypass a security protocol that depends on the particular encryption algorithm for which the key provides access. The digital media player may not be readily reformatable to decrypt and/or demultiplex other encryption algorithms not accessible by a stolen key. Thus, the security of a particular line of digital media players may become compromised. Consequently, the method of a copyright owner of encrypting and/or multiplexing media content to protect it from unauthorized use (e.g. copying, theft, unlicensed public use, etc.) may be compromised and/or become ineffective.

### SUMMARY

The method, system, and apparatus of key exchange through a scramble methodology and system is disclosed. In one aspect, the method includes generating a security key associated with a protected media content, disassembling the security key (e.g., may be an unencrypted key) into a set of key bits, generating non-key bits (e.g., may be arbitrarily and/or randomly created binary numbers), placing the non-key bits disbursed between at least some of the set of key bits based on an algorithm of a control register module of a scatter module, algorithmically specifying a number of the set of key bits and the non-key bits in a packet (e.g., the packet and/or the other packets collectively may form a scattered key), and communicating the packet and other packets each having the non-key bits disbursed between at least some of the set of key bits of each of the packet and the other packets to a gather module.

The non-key bits disbursed between some of the set of key bits of the packet and/or the other packets form a pattern that may be repeated after every ‘n’ number of packets forming the scattered key. The control register module of the scatter module may be associated with algorithms each associated with a different pattern of disbursement of the non-key bits between some of the set of key bits forming the scattered key. The gather module, locating key bits of the packet and/or the other packets using reverse algorithms associated with another control register module.

The another control register module of the gather module may include reverse algorithms to the algorithms of the scatter module, (e.g., the reverse algorithms may enable reconstruction of the security key by identifying key bits of the packet and/or the other packets forming the scattered key). The scatter module and/or the gather module determine placement of the key bits by identifying a number of bit offsets between subsequent key bits separated by non-key bits through algorithms. The security key may be associated with a media security module of a playback device. The method may include replacing the algorithm when the algorithm is compromised with another algorithm of the control register module and/or applying a matching reverse algorithm to the another algorithm through the gather module.

In another aspect, the system includes a library of algorithms module of a first security module to store a library of algorithms that determine a generation, disassembly, location, communication and reassembly of a key, a control register module of the first security module to determine an algorithm from the library of algorithms, a key generator module of the first security module to generate the security key according to the algorithm, a non-key bit module of the first security module to generate a plurality of non-key bits, a key disassembly module of the first security module to disassemble the security key into a set of key bits according to the algorithm, a packet module (e.g., may create a specified number of packets that contain zero key bits according to the algorithm) of the first security module to create a packet from an algorithmically specified number of key bits of the set of key bits and non-key bits disbursed between at least some of the algorithmically specified number of key bits and locate each of the algorithmically specified number of key bits in an algorithmically specified location of the packet, a communication module of the first security module to communicate the packet to a receiver module of a second security module, another library of algorithms of the second security module to store a reverse set of algorithms corresponding to the library of algorithms of the library of algorithms module of the first security module, an algorithm determination module of the second security module to select a reverse algorithm from the another library of algorithms, and a key identification module of the second security module to locate the set of key bits in a plurality of the packets according to the reverse algorithm, a key extraction module of the second security module to extract the set of key bits from the packet according to the reverse algorithm, a storage module of the second security module to store the set of key bits, and a reassembly module of the second security module to assemble the set of key bits into the security key according to the reverse algorithm.

The system may include another control register module of the second security module to receive an instruction from the first security module that may set the reverse algorithm used by the second security module. The system may also include, a hash table module of the first security module to generate the security key using a hash table by using a data structure that may associate an indexed portion of a data group with an output of a function according to a specified hash function. The method may further include a pattern module of the first security module to repeat the non-key bits after every ‘n’ number of packets.

In yet another aspect, the system includes a first security module configured according to an algorithm to generate a security key, to disassemble the security key into a set of key bits, and to insert an algorithmically specified number of key bits into a packet comprised of a plurality of non-key bits placed between at least some of the key bits, and a second security module configured according to a reverse algorithm to receive the packet and other packets, to recognize each key bit from the packet and other packets, to extract each key bit, to store each key bit as the set of key bits and to reassemble the set of key bits into the security key.

The system may include, a first control register module of the first security module to determine the algorithm of the first security module from a library of algorithms of the first security module and/or communicate an identity of the algorithm to a second control register of the second security module that may include another library of algorithms having a matching set of reverse algorithms as the library of algorithms module of the first security module. The first security module the algorithm may be replaced when the algorithm may be compromised with another algorithm of the control register module and another reverse algorithm is matched to the another algorithm through the second security module. The non-key bits may be disbursed between the specified number of key bits of the packet and/or specified number of key bits in other packets in a pattern that may be repeated after every ‘n’ number of packets forming a scattered version of the key.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view in which play back device communicates with protected media content, according to one embodiment.

FIG. 2 is an exploded view of media security module of FIG. 1, according to one embodiment.

FIG. 3 is an exploded view of scatter module of FIG. 2, according to one embodiment.

FIG. 4 is an exploded view of gather module of FIG. 2, according to one embodiment.

FIG. 5 is a diagrammatic system view of a data processing system in which any of the embodiments disclosed herein may be performed, according to one embodiment, according to one embodiment.

FIG. 6 is a pattern view of repeating scatter pattern of the packet 226, according to one embodiment.

FIG. 7 is an exploded view of packet 230 of FIG. 2, according to one embodiment.

FIG. 8 is a process flow of generating a security key associated with protected media content, according to one embodiment.

Other features of the present embodiments will be apparent from the accompanying drawings and from the detailed description that follows.

### DETAILED DESCRIPTION

The method, system, and apparatus key exchange through a scramble methodology and system is disclosed. Although the present embodiments have been described with reference to specific example embodiments, it will be evident that various modifications and changes may be made to these embodiments without departing from the broader spirit and scope of the various embodiments.

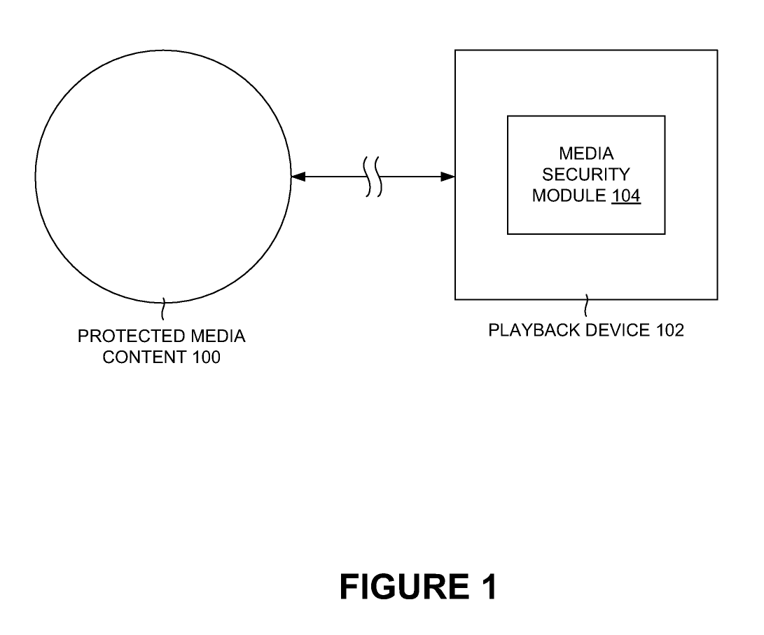

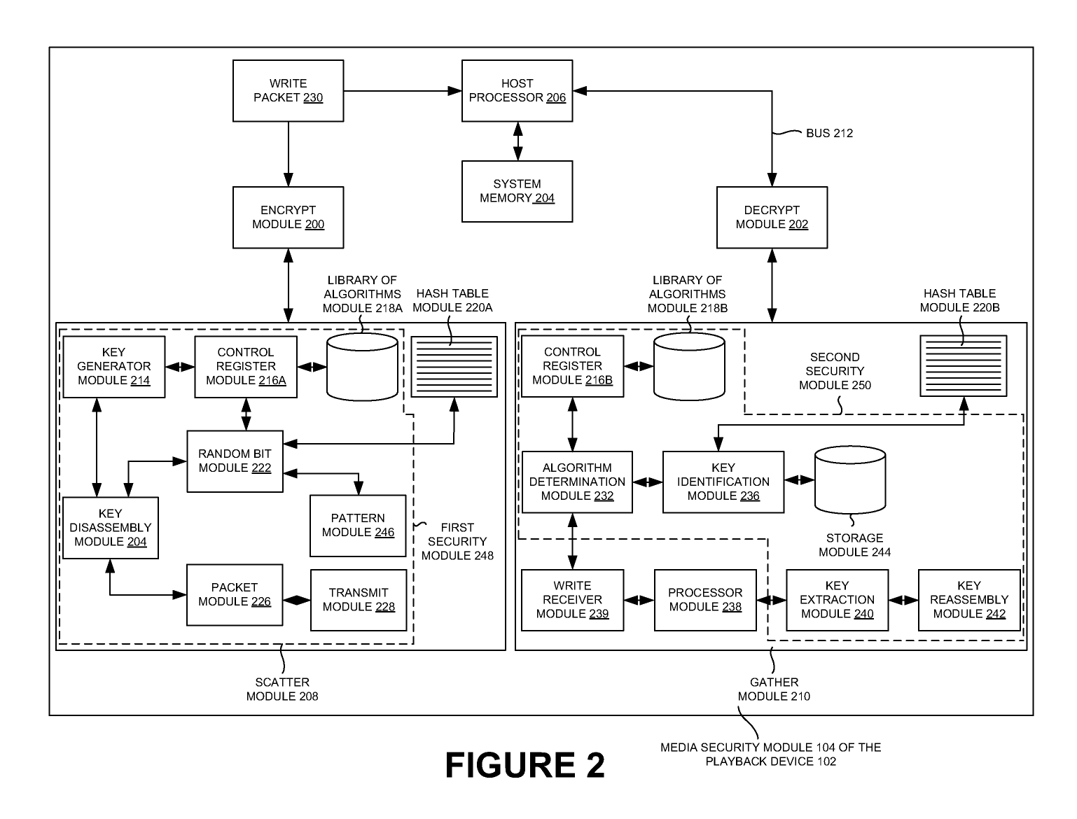

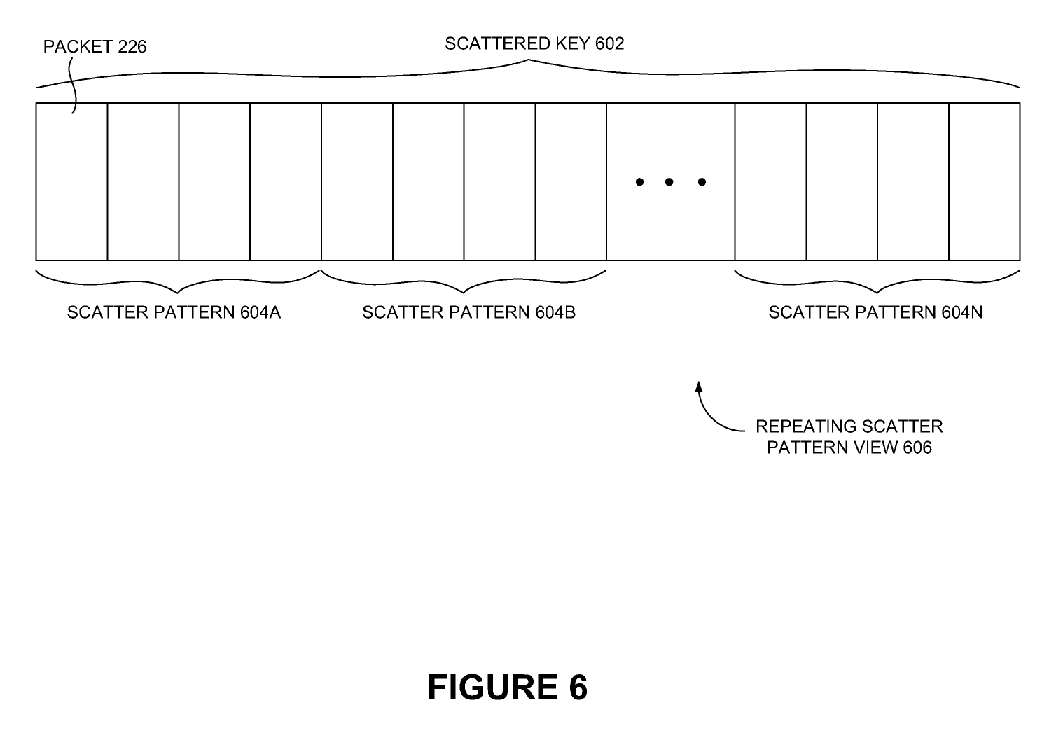

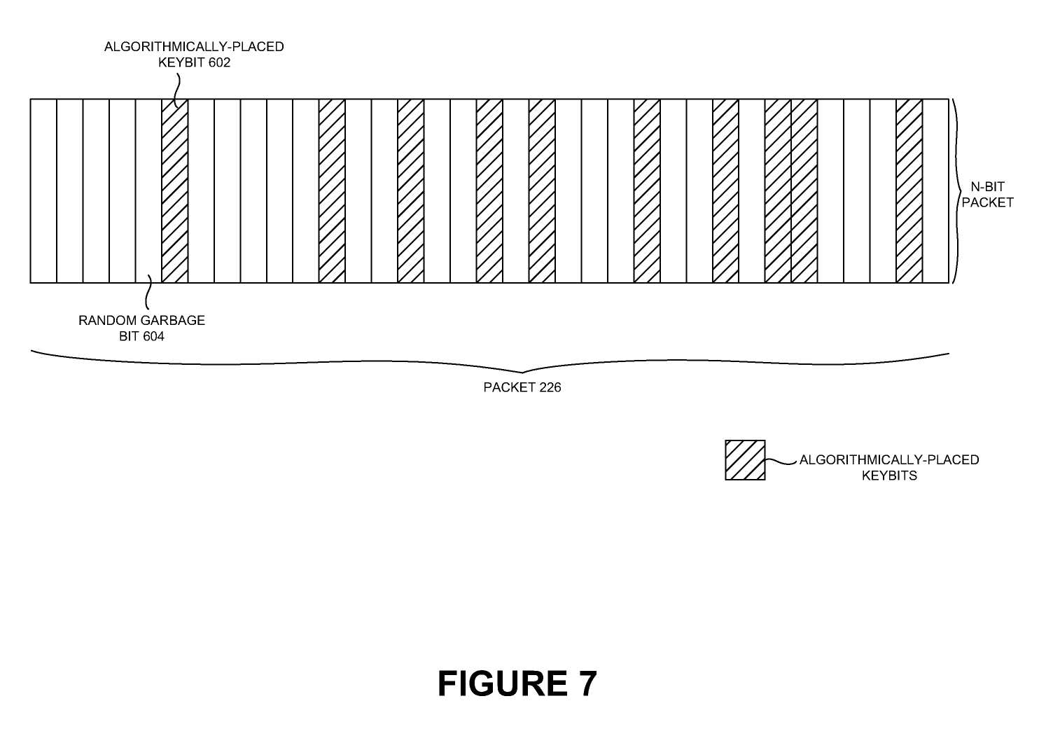

In one embodiment, the method includes generating a security key associated with a protected media content (e.g., the protected media content 100 of FIG. 1), disassembling the security key (e.g., may be an unencrypted key) into a set of key bits, generating non-key bits (e.g., may be arbitrarily and/or randomly created binary numbers), placing the non-key bits (e.g., may be random non-key bit 604 of FIG. 6) disbursed between at least some of the set of key bits based on an algorithm of a control register module (e.g., the control register module 216A of FIG. 2) of a scatter module (e.g., the scatter module 208 of FIG. 2), algorithmically specifying a number of the set of key bits and the non-key bits in a packet (e.g., the packet 230 of FIG. 2) (e.g., the packet and/or the other packets collectively may form a scattered key), and communicating the packet 230 and other packets each having the non-key bits disbursed between at least some the set of key bits of each of the packet and the other packets (e.g., as illustrated in FIG. 7) to a gather module (e.g., the gather module 210 of FIG. 2).

In another embodiment, the system includes a library of algorithms module (e.g., the library of algorithms module 218A and 218B of FIG. 2) of a first security module (e.g., the first security module 248 of FIG. 2) to store a library of algorithms that determine a generation, disassembly, location, communication and reassembly of a key, a control register module (e.g., the control register module 216A and 216B of FIG. 2) of the first security module 248 to determine an algorithm from the library of algorithms, a key generator module (e.g., the key generator module 214 of FIG. 2) of the first security module 248 to generate the security key according to the algorithm, a non-key bit module (e.g., the non-key bit module 222 of FIG. 2) of the first security module 248 to generate a plurality of non-key bits, a key disassembly module (e.g., the key disassembly module 224 of FIG. 2) of the first security module 248 to disassemble the security key into a set of key bits according to the algorithm, a packet module (e.g., the packet module 226 of FIG. 2) (e.g., may create a specified number of packets that contain zero key bits according to the algorithm) of the first security module 248 to create a packet (e.g., the packet 230 of FIG. 2) from an algorithmically specified number of key bits of the set of key bits and non-key bits disbursed between at least some of the algorithmically specified number of key bits and locate each of the algorithmically specified number of key bits in an algorithmically specified location of the packet 230, a communication module (e.g., the communication module 228 of FIG. 2) of the first security module 248 to communicate the packet 230 to a receiver module (e.g., the receiver module 239 of FIG. 2) of a second security module (e.g., the second security module 250 of FIG. 2), another library of algorithms of the second security module 250 to store a reverse set of algorithms corresponding to the library of algorithms of the library of algorithms module 218B of the first security module 248, an algorithm determination module (e.g., the algorithm determination module 232 of FIG. 2) of the second security module 250 to select a reverse algorithm from the another library of algorithms, and a key identification module (e.g., the key identification module 236 of FIG. 2) of the second security module 250 to locate the set of key bits in a plurality of the packets according to the reverse algorithm, a key extraction module (e.g., the key extraction module of FIG. 2) of the second security module 250 to extract the set of key bits from the packet 230 according to the reverse algorithm, a storage module (e.g., the storage module 244 of FIG. 2) of the second security module 250 to store the set of key bits, and a reassembly module (e.g., the key reassembly module 242 of FIG. 2) of the second security module 250 to assemble the set of key bits into the security key according to the reverse algorithm.

In yet another embodiment, the system includes, a first security module (e.g., the first security module 248 of FIG. 2) configured according to an algorithm to generate a security key, to disassemble the security key into a set of key bits, and to insert an algorithmically specified number of key bits into a packet 230 comprised of a plurality of non-key bits placed between at least some of the key bits, and a second security module (e.g., the second security module 250 of FIG. 2) configured according to a reverse algorithm to receive the packet 230 and other packets, to recognize each key bit from the packet 230 and other packets, to extract each key bit, to store each key bit as the set of key bits and to reassemble the set of key bits into the security key.

FIG. 1 is a system view of play back device communicating with protected media content, according to one embodiment. Particularly, FIG. 1 illustrates protected media content 100, a playback device 102, and a media security module 106, according to one embodiment.

The protected media content 100 may be data content present in storage devices (e.g., HD-DVD disk and/or a Blue-Ray disc) having a work of authorship (e.g., a movie, a television show, a play, a music data, etc.). In an alternate embodiment, the protected media content 100 may be received via any networking protocol (e.g., wireless or wired protocol). The playback device 102 may be a personal computer, a standalone media player, a mobile audio/video player, a mobile phone, and/or a kiosk. The media security module 106 may secure (e.g., may be by encrypting, decrypting, etc.) the media data (e.g., audio, video, etc.).

In example embodiment, FIG. 1 illustrates the playback device 102 may access the protected media content 100 to use the media content for some defined purpose (e.g., transmission, playback, etc.). The playback device 102 may include the media security module 104. The media security module enables encryption/decryption of the secured media data, according to one embodiment.

FIG. 2 is an exploded view of media security module illustrated in FIG. 1, according to one embodiment. Particularly, FIG. 2 illustrates the media security module 106, an encrypt module 200, a decrypt module 202, a system memory 204, a host processor 206, a scatter module 208, a gather module 210, a bus 212, a key generator module 214, a control register module 216A, a control register module 216B, a library of algorithms module 218A, a library of algorithms module 218B, a hash table 220A, a hash table 220B, a non-key bit module 222, a key disassembly module 224, a packet module 226, a communication module 228, a packet 230, an algorithm determination module 232, a key identification module 236, a processor module 238, a receiver module 239, a key extraction module 240, a key reassembly module 242, a storage module 244, a pattern module 246, a first security module 248, and a second security module 250, according to one embodiment.

The encrypt module 200 may encrypt (e.g., the information) the packet 230 (e.g., that may include set of key bits, the non-key bits, etc.). The decrypt module 202 may decrypt the packet 230 (e.g., the packets of the media data). The system memory 204 may be manage the memory (e.g., may be the dynamic random access memory, flash memory, etc.) of the playback device 102. The host processor 206 may process flow of data, encryption, decryption process and other process that may be required to use the media data effectively. The scatter module 208 may have algorithms that may be used to determine the placement of key bits and non-key bits between the key-bits. The gather module 210 may collect (e.g., gather) all the disbursed packets (e.g., that may contain the key bits and the non-key bits). The bus 212 may be an interface that allows communication between various modules and/or structures of the data processing system (e.g., the play back device).

The key generator module 214 of first security module 248 may generate the security key (e.g., may be an encrypted key) using an algorithm. The control register module 216A associated with the first security module 248 may determine an algorithm from the library of algorithms (e.g., associated with the library of algorithms module 218A). The library of algorithms module 218A associated with the first security module 248 may store a library of algorithms that may determine a generation, assemble, location, communication and reassembly of a key. The library of algorithms module 218B of the second security module 250 may store a reverse set of algorithms corresponding to the library of algorithms that may be associated with library of algorithms module 218A of the first security module 248

The hash table module 220A may generate the security key using a hash table (e.g., look up table) by using a data structure that may associate an indexed portion of a data group with an output of a function according to a specified hash function. The hash table 220B may be used to generate (e.g., the security key, data structure, etc.) that may be associated with an indexed portion of the data group coupled with an output in relation to hash function. The non-key bit module 222 of the first security module 248 may generate non-key of bits (e.g., may be arbitrarily and created binary numbers). The key disassembly module 224 may disassemble the security key into a set of key bits, as per the algorithms. The packet module 226 may create a specified number of packets that may contain zero key bits according to the algorithm. The communication module 228 may communicate the packet 230 to the receiver module 239 of second security module 250.

The packet 230 may be a logical group (e.g., large data broken into small units for transmitting over network) of data of a certain size in bytes which may include the set of key bits and the non-key bits. The algorithm determination module 232 may select a reverse algorithm from the library of algorithms that may be associated with library of algorithms module 218B. The key identification module 236 may locate a set of key bits in the packets according to the reverse algorithm.

The processor module 238 may enable processing (e.g., reassembling, extracting, etc.) the set of key bits from the packet with reference to the reverse algorithm. The receiver module 239 may enable receiving (e.g., reassembling, extracting, etc.) the set of key bits that may be processed from the packet with reference to the reverse algorithm. The key extraction module 240 may extract the set of key bits from the packet 230 according to the reverse algorithm. The key reassembly module 242 may assemble the set of key bits into the security key. The storage module 244 associated with second security module 250 may store the set of key bits. The pattern module 246 may repeat the non-key bits after every ‘n’ number of packets. The first security module 248 may generate a security key and disassemble into a set of key bits. The second security module 250 may receive the packet 230 and other packets and may recognize and extract each key bit from the packet 230 and other packets.

In example embodiment, the scatter module 208 may communicate with encrypt module 200 to encrypt the key. The encrypt module 200 may communicate with packet 230 and to system memory 204 through the host processor 206. The system memory 204 may communicate with decrypt module 202 which may in turn communicate with the gather module 210.

In one embodiment, the security key associated with the protected media content 100 may be generated. The security key may be disassembled into a set of key bits. The non-key bits may be generated (e.g., using the non-key bit module 222 of FIG. 2). The non-key bits disbursed between some of the set of key bits (e.g., using the packet module 226 of FIG. 2) may be placed based on the algorithm of a control register module 216A-B of the scatter module 208. The number of the set of key bits and the non-key bits may be algorithmically specified in the packet 230 (e.g., using the packet module 226 of FIG. 2). The packet 230 and other packets each having the non-key bits disbursed between some the set of key bits of each of the packet 230 and the other packets may be communicated to the gather module 210.

The packet 230 and/or the other packets collectively may form a scattered key (e.g., the scattered key 602 of FIG. 6). The non-key bits disbursed between some of the set of key bits of the packet 230 and/or the other packets form a pattern that may be repeated after every ‘n’ number of packets forming the scattered key (e.g., using the packet module 226 of FIG. 2). The control register module 216A-B of the scatter module 208 may be associated with algorithms each associated with a different pattern of disbursement of the non-key bits between some of the set of key bits forming the scattered key 602. In the gather module 210, locating key bits of the packet 230 and/or the other packets of reverse algorithms may be associated with another control register module (e.g., the control register module 216B of FIG. 2).

The another control register module of the gather module 210 may include reverse algorithms to algorithms of the scatter module 208, (e.g., such that the reverse algorithms enable reconstruction of the security key by identifying key bits of the packet 230 and/or the other packets may form the scattered key 602). The scatter module 208 and/or the gather module 210 may determine placement of the key bits by identifying a number of bit offsets between subsequent key bits separated by non-key bits through algorithms. The security key may be an unencrypted key. The non-key bits may be arbitrarily and/or randomly created binary numbers.

The security key may be associated with the media security module 106 of the playback device 102. When the algorithm may be compromised with another algorithm of the control register module, the algorithm may be replaced and a matching reverse algorithm may be applied to the another algorithm through the gather module 210.

The library of algorithms module 218A-B of the first security module 248 may store a library of algorithms that may determine a generation, disassembly, location, communication and/or reassembly of a key. The control register module 216A of the first security module 248 may determine an algorithm from the library of algorithms. The key generator module 214 of the first security module 248 may generate the security key according to the algorithm. The non-key bit module 222 of the first security module 248 may generate a non-key bits.

The key disassembly module 224 of the first security module 248 may disassemble the security key into a set of key bits according to the algorithm. The packet module 226 of the first security module 248 may create the packet 230 from an algorithmically specified number of key bits of the set of key bits and/or non-key bits disbursed between some of the algorithmically specified number of key bits and locate each of the algorithmically specified number of key bits in an algorithmically specified location of the packet 230. The communication module 228 of the first security module 248 may communicate the packet 230 to the receiver module 239 of the second security module 250.

Another library of algorithms of the second security module 250 may store a reverse set of algorithms may correspond to the library of algorithms of the library of algorithms module 218A-B of the first security module 248. The algorithm determination module 232 of the second security module 250 may select a reverse algorithm from the another library of algorithms. The key identification module 236 of the second security module 250 may locate the set of key bits in packets according to the reverse algorithm. The key extraction module 240 of the second security module 250 may extract the set of key bits from the packet 230 according to the reverse algorithm. The storage module 244 of the second security module 250 may store the set of key bits.

The reassembly module of the second security module 250 may assemble the set of key bits into the security key according to the reverse algorithm. Another control register module of the second security module 250 may receive an instruction from the first security module 248 that may set the reverse algorithm used by the second security module 250. The hash table module 220A of the first security module 248 may generate the security key using a hash table by using a data structure that may associate an indexed portion of a data group with an output of a function according to a specified hash function. The packet module 226 may create a specified number of packets that may contain zero key bits according to the algorithm. The pattern module 246 of the first security module 248 may repeat the non-key bits after every ‘n’ number of packets.

The first security module 248 may be configured according to an algorithm to generate a security key, may disassemble the security key into a set of key bits, and may insert an algorithmically specified number of key bits into a packet comprised of non-key bits placed between the key bits. The second security module 250 may be configured according to a reverse algorithm to receive the packet 230 and/or other packets, to recognize each key bit from the packet 230 and/or other packets, which may extract each key bit. The second circuit module 250 may be configured to store each key bit as the set of key bits and/or to reassemble the set of key bits into the security key.

The first control register module of the first security module 248 may determine the algorithm of the first security module 248 from a library of algorithms of the first security module 248 and communicate an identity of the algorithm to a second control register of the second security module 250 that may include another library of algorithms having a matching set of reverse algorithms as the library of algorithms module 218A of the first security module 248. In the first security module 248 the algorithm may be replaced when the algorithm is compromised with another algorithm of the control register module 216B and another reverse algorithm may be matched to the another algorithm through the second security module 250. The non-key bits may be disbursed between the specified number of key bits of the packet 230 and/or specified number of key bits in other packets in a pattern that may be repeated after every ‘n’ number of packets forming a scattered version of the key.

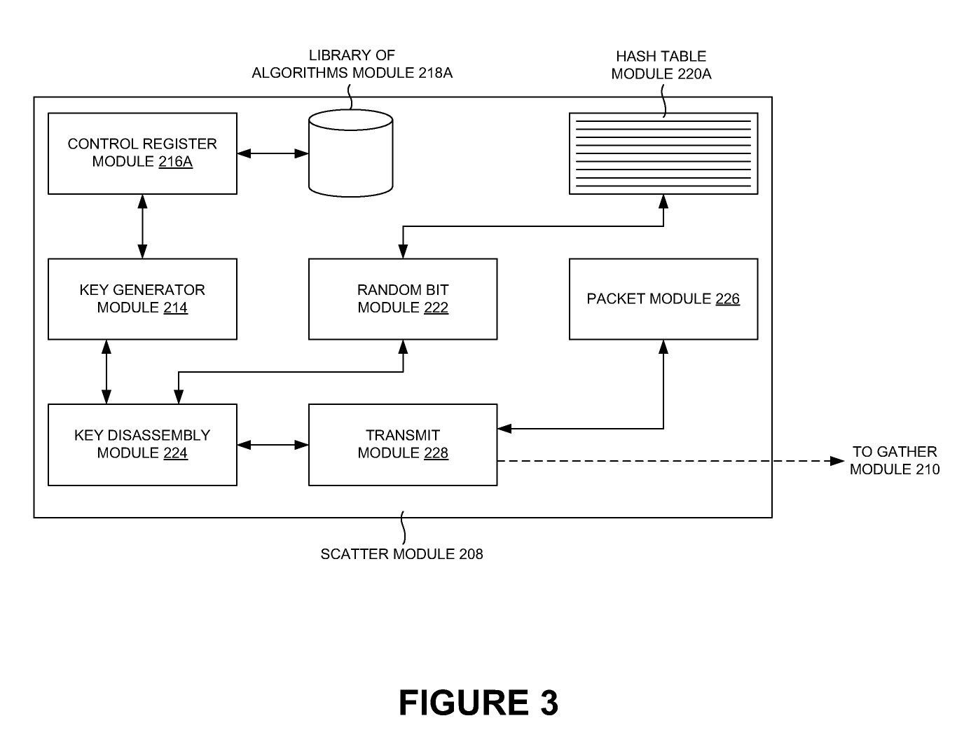

FIG. 3 is an exploded view of scatter module 208 illustrated in FIG. 2, according to one embodiment. Particularly, FIG. 3 illustrates, the scatter module 208, the key generator module 214, the control register module 216A, the library of algorithms module 218A, the hash table module 220A, the non-key bit module 222, the key disassembly module 224, the packet module 226, the communication module 228, and the pattern module 246, according to one embodiment.

In example embodiment, the scatter module 208 may include a key generator module 214 may communicate with key disassembly module 224, and control register module 216A. The communication module 228 may communicate with the packet module 226 and the pattern module 246. The non-key bit module 222 may communicate with the hash table module 220A. The communication module 228 may further communicate with gather module 210, according to one embodiment.

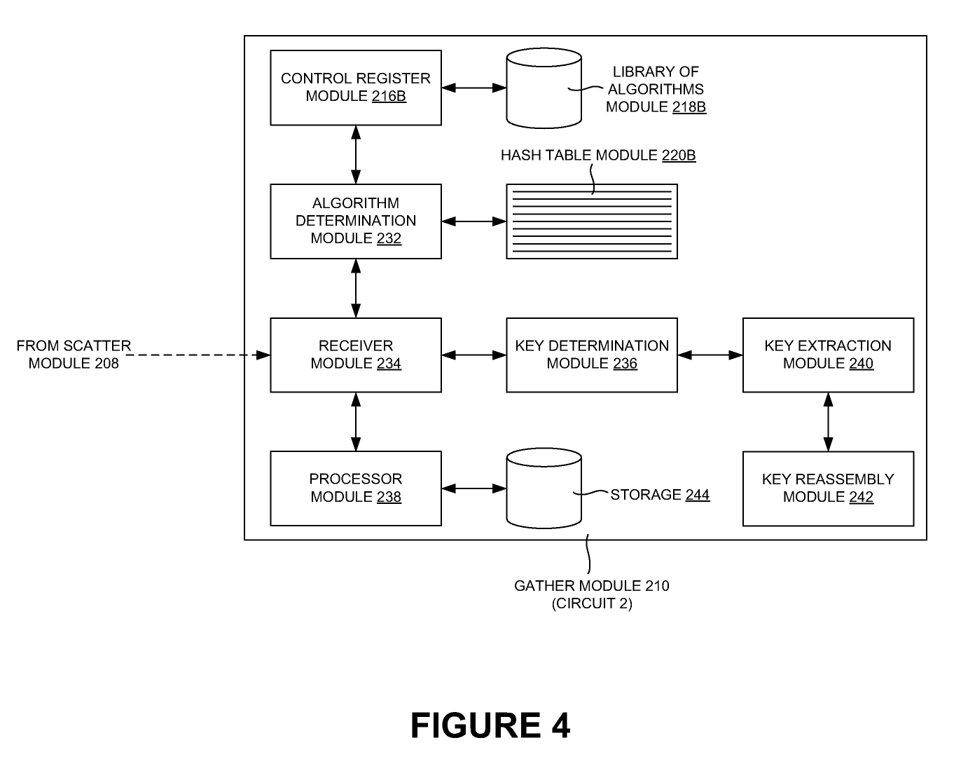

FIG. 4 is an exploded view of gather module 210 illustrated in FIG. 2, according to one embodiment. Particularly, FIG. 4 illustrates, the gather module 210, the control register module 216B, the library of algorithms module 218B, the algorithm determination module 232, the hash module 220B, the receiver module 234, the key identification module 236, the key extraction module 240, the processor module 238, the storage module 244, and the key reassembly module 242, according to one embodiment.

In example embodiment, the gather module 210 may include the control register module 216B communicating with the library of algorithms module 218B. The algorithm determination module 232 may communicate with the receiver module 234, and hash module 220B. The storage module 244 may communicate with key identification module 236 and processor module 238. The key extraction module 240 may communicate with key reassembly module 242 and key identification module 236.

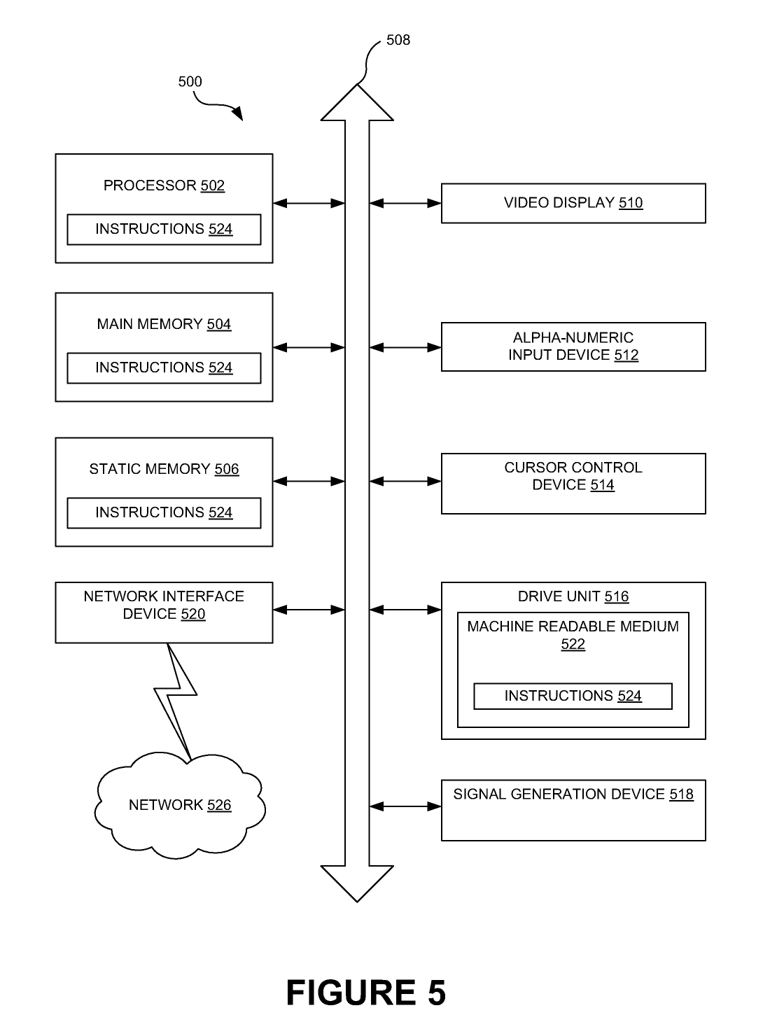

FIG. 5 is a diagrammatic system view of a data processing system in which any of the embodiments disclosed herein may be performed, according to one embodiment, according to one embodiment. Particularly, FIG. 5 illustrates the diagrammatic system view 500 of FIG. 5 illustrates a processor 502, a main memory 504, a static memory 506, a bus 508, a video display 510, an alpha-numeric input device 512, a cursor control device 514, a drive unit 516, a signal generation device 518, a network interface device 520, a machine readable medium 522, instructions 524, and a network 526, according to one embodiment.

The diagrammatic system view 500 may indicate a personal computer and/or the data processing system in which one or more operations disclosed herein are performed. The processor 502 may be a microprocessor, a state machine, an application specific integrated module, a field programmable gate array, etc. (e.g., Intel® Pentium® processor). The main memory 504 may be a dynamic random access memory and/or a primary memory of a computer system.

The static memory 506 may be a hard drive, a flash drive, and/or other memory information associated with the data processing system. The bus 508 may be an interconnection between various circuits and/or structures of the data processing system. The video display 510 may provide graphical representation of information on the data processing system. The alpha-numeric input device 512 may be a keypad, a keyboard and/or any other input device of text (e.g., a special device to aid the physically handicapped).

The cursor control device 514 may be a pointing device such as a mouse. The drive unit 516 may be the hard drive, a storage system, and/or other longer term storage subsystem. The signal generation device 518 may be a bios and/or a functional operating system of the data processing system. The network interface device 520 may be a device that performs interface functions such as code conversion, protocol conversion and/or buffering required for communication to and from the network 526. The machine readable medium 522 may provide instructions on which any of the methods disclosed herein may be performed. The instructions 524 may provide source code and/or data code to the processor 502 to enable any one or more operations disclosed herein.

FIG. 6 is a pattern view of repeating scatter, according to one embodiment. Particularly, FIG. 6 illustrates the packet 230, a scattered key 602, a scatter pattern 604A-N, and a repeating scatter pattern view 606, according to one embodiment.

The scattered key 602 may be a set of keys that may be scattered across the packets in a particular pattern. The scatter pattern 604A-N may represent the pattern of the scattering of the keys (e.g., using the scatter module 208 of FIG. 2) according to an algorithm. The repeating scatter pattern view 606 may be the pattern view that may have repeated number of packets of some of the set of key bits of the packet and other packets.

In example embodiment, the repeating scatter pattern view 606 may illustrate a pattern of the scattered key 602 across a set of packets. The pattern view may illustrate the scatter pattern 604A-N that may repeat itself for a specified number of packets.

FIG. 7 is an exploded view of packet 230 illustrated in FIG. 2, according to one embodiment. Particularly, FIG. 7 illustrates the packet 230, a random non-key bit 604, and an algorithmically-placed key bit 602A-C, according to one embodiment.

The algorithmically-placed key bit 602A-C may be the key bits placed in the n-bit packet according to the algorithm (e.g., using the library of algorithms module 218A). The random non-key bit 604 may be the non-key bit that may be randomly placed in the n-bit packet.

In example embodiment, the packet 230 may illustrate n-bit packet. The packet 230 may consist of random non-key bit 604 and algorithmically-placed keybit 602A arranged consecutively in the packet 230. The packet 230 may also illustrate the algorithmically-placed keybit 602B, and algorithmically-placed keybit 602C.

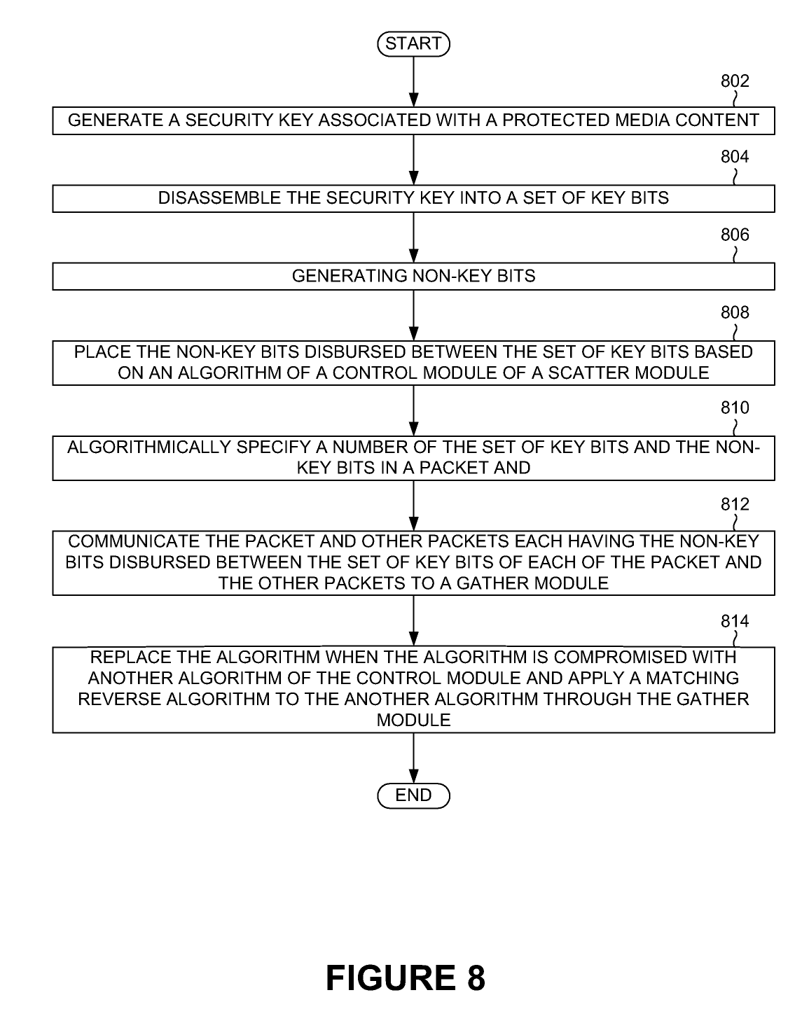

FIG. 8 is a process flow of generating a security key associated with a protected media content (e.g., the protected media content 100 of FIG. 1), according to one embodiment. In operation 802, a security key associated with protected media content (e.g., the protected media content 100 of FIG. 1) may be generated (e.g., using the key generator module 214 of FIG. 2). In operation 804, the security key may be disassembled (e.g., using the key disassembly module 224 of FIG. 2) into a set of key bits. In operation 806, non-key bits may be generated (e.g., using the non-key bit module 222 of FIG. 2).

In operation 808, the non-key bits disbursed between some of the set of key bits (e.g., using the packet module 226 of FIG. 2) may be placed based on a control register module (e.g., the control register module 216A-B of FIG. 2) of a scatter module (e.g., the scatter module 208 of FIG. 2). In operation 810, a number of the set of key bits and the non-key bits may be algorithmically specified in a packet (e.g., the packet 230 of FIG. 2) (e.g., using the packet module 226 of FIG. 2). In operation 812, the packet 230 and other packets each having the non-key bits disbursed between some the set of key bits of each of the packet 230 and the other packets may be communicated to a gather module (e.g., the gather module 210 of FIG. 2).

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

Particularly, the media security module 106, the encrypt module 200, the decrypt module 202, the host processor 206, the scatter module 208, the gather module 210, the key generator module 214, the control register module 216A, the control register module 216B, the library of algorithms module 218A, the library of algorithms module 218B, the non-key bit module 222, the key disassembly module 224, the packet module 226, the communication module 228, the algorithm determination module 232, the key identification module 236, the processor module 238, the receiver module 239, the key extraction module 240, the key reassembly module 242, the storage module 244, the pattern module 246, the first security module 248, and the second security module 250, may be enabled using software and/or using transistors, logic gates, and electrical circuits (e.g., application specific integrated ASIC circuitry) such as a media security circuit, an encrypt circuit, a decrypt circuit, a scatter circuit, a gather circuit, a key generator circuit, a control register circuit, a control register circuit, a library of algorithm circuit, a library of algorithm circuit, a non-key bit circuit, a key disassembly circuit, a packet circuit, a communication circuit, an algorithm determination circuit, a key identification circuit, a processor circuit, a receiver circuit, a key extraction circuit, a key reassembly circuit, a storage circuit, a pattern circuit, a first security circuit, and a second security circuit, and other circuit.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

1. A method comprising:
generating a security key associated with a protected media content;
disassembling the security key into a set of key bits;
generating non-key bits;
placing the non-key bits disbursed between at least some of the set of key bits based on an algorithm of a control register module of a scatter module;
algorithmically specifying a number of the set of key bits and the non-key bits in a packet; and
communicating the packet and other packets each having the non-key bits disbursed between at least some the set of key bits of each of the packet and the other packets to a gather module.

2. The method of claim 1 further comprising wherein the packet and the other packets collectively form a scattered key.

3. The method of claim 2 wherein the non-key bits disbursed between at least some of the set of key bits of the packet and the other packets form a pattern that is repeated after every ‘n’ number of packets forming the scattered key.

4. The method of claim 3 wherein the control register module of the scatter module is associated with a plurality of algorithms each associated with a different pattern of disbursement of the non-key bits between at least some of the set of key bits forming the scattered key.

5. The method of claim 4 wherein in the gather module, locating key bits of the packet and the other packets using at least one of a plurality of reverse algorithms associated with another control register module.

6. The method of claim 5 wherein the another control register module of the gather module includes the plurality of reverse algorithms to the plurality of algorithms of the scatter module, such that the plurality of reverse algorithms enable reconstruction of the security key by identifying key bits of the packet and the other packets forming the scattered key.

7. The method of claim 6 wherein the scatter module and the gather module determine placement of the key bits by identifying a number of bit offsets between subsequent key bits separated by non-key bits through at least one of the plurality of algorithms.

8. The method of claim 1:
wherein the security key is an unencrypted key, and wherein the non-key bits are arbitrarily and randomly created binary numbers; and
wherein the security key is associated with a media security module of a playback device.

9. The method of claim 1 further including replacing the algorithm when the algorithm is compromised with another algorithm of the control register module and applying a matching reverse algorithm to the another algorithm through the gather module.

10. The method of claim 1 in a form of a machine-readable medium embodying a set of instructions that, when executed by a machine, causes the machine to perform the method of claim 1.

11. A system comprising:
a library of algorithms module of a first security module to store a library of algorithms that determine a generation, disassembly, location, communication and reassembly of a key;
a control register module of the first security module to determine an algorithm from the library of algorithms;
a key generator module of the first security module to generate the security key according to the algorithm;
a non-key bit module of the first security module to generate a plurality of non-key bits;
a key disassembly module of the first security module to disassemble the security key into a set of key bits according to the algorithm;
a packet module of the first security module to create a packet from an algorithmically specified number of key bits of the set of key bits and non-key bits disbursed between at least some of the algorithmically specified number of key bits and locate each of the algorithmically specified number of key bits in an algorithmically specified location of the packet;
a communication module of the first security module to communicate the packet to a receiver module of a second security module;
another library of algorithms of the second security module to store a reverse set of algorithms corresponding to the library of algorithms of the library of algorithms module of the first security module;
an algorithm determination module of the second security module to select a reverse algorithm from the another library of algorithms; and
a key identification module of the second security module to locate the set of key bits in a plurality of the packets according to the reverse algorithm;
a key extraction module of the second security module to extract the set of key bits from the packet according to the reverse algorithm;
a storage module of the second security module to store the set of key bits; and
a reassembly module of the second security module to assemble the set of key bits into the security key according to the reverse algorithm;

12. The system of claim 11 further comprising another control register module of the second security module to receive an instruction from the first security module that sets the reverse algorithm used by the second security module.

13. The system of claim 12 further comprising a hash table module of the first security module to generate the security key using a hash table by using a data structure that associates an indexed portion of a data group with an output of a function according to a specified hash function.

14. The system of claim 11 wherein the packet module creates a specified number of packets that contain zero key bits according to the algorithm.

15. The system of claim 11 further comprising a pattern module of the first security module to repeat the non-key bits after every ‘n’ number of packets.

16. A system comprising:
a first security module configured according to an algorithm to generate a security key, to disassemble the security key into a set of key bits, and to insert an algorithmically specified number of key bits into a packet comprised of a plurality of non-key bits placed between at least some of the key bits; and
a second security module configured according to a reverse algorithm to receive the packet and other packets, to recognize each key bit from the packet and other packets, to extract each key bit, to store each key bit as the set of key bits and to reassemble the set of key bits into the security key.

17. The system of claim 16 further comprising a first control register module of the first security module to determine the algorithm of the first security module from a library of algorithms of the first security module and communicate an identity of the algorithm to a second control register module of the second security module that includes another library of algorithms having a matching set of reverse algorithms as the library of algorithms module of the first security module.

18. The system of claim 16 wherein the first security module is implemented in hardware and the second security module is implemented in at least one of hardware and software in a form of a machine-readable medium embodying a set of instructions that, when executed by a machine, causes the machine to perform the system of claim 15.

19. The system of claim 16 wherein the first security module the algorithm is replaced when the algorithm is compromised with another algorithm of the control register module and another reverse algorithm is matched to the another algorithm through the second security module.

20. The system of claim 16 wherein the plurality of non-key bits are disbursed between the specified number of key bits of the packet and specified number of key bits in other packets in a pattern that is repeated after every ‘n’ number of packets forming a scattered version of the key.
